(19) United States
(12) Patent Application Publication
(10) Pub. No.: US 2008/0164127 A1
(43) Pub. Date: Jul. 10, 2008

(54) Needled felt and monofilament fabric conveyor belt

(75) Inventor: John Hawkins, Loganville, GA (US)

Correspondence Address: DUANE MORRIS LLP, PO BOX 5203, PRINCETON, NJ, 08543-5203, US

(73) Assignee: J.H. Fenner & Co. Ltd

(21) Appl. No.: 11/651,837

(22) Filed: Jan. 10, 2007

(51) Int. Cl. B65G 15/30

(52) U.S. Cl. 198/844.1

(57) ABSTRACT

A conveyor belt construction is disclosed comprising at least one layer of carded non-woven material and one layer of woven fabric that are needled together to form a carcass structure. The layer of non-woven material is carded so that a substantial portion of the staple fibers are oriented in a first direction. The layer of woven material has multifilament warp fibers and monofilament weft fibers. The two layers of material are layered on each other and needled together to form a multi-layer carcass. The carcass is then impregnated with an elastomeric material, resulting in a belt having low operating noise, high lateral strength, and good resistance to belt fastener pull-out. A second non-woven layer can be applied to the woven layer such that the woven layer is sandwiched between the non-woven layers. A method for manufacturing the multi-layer belt is also disclosed.

### CROSS-REFERENCE TO RELATED APPLICATIONS

This application is related to co-pending U.S. patent application Ser. No. 11/542,481 filed Oct. 3, 2006, by Hawkins et al., titled “Oriented Needled Felt Conveyor Belt,” the entirety of which application is incorporated by reference herein.

### FIELD OF THE INVENTION

The invention generally relates to an improved low noise conveyor belt design, and more particularly to a design for a needled felt conveyor belt having a monofilament weft reinforcing layer for improved strength.

### BACKGROUND

Conveyor belts and conveyor systems are well known systems used for the transport of a variety of materials and products. Conveyor belts are designed and used in heavy materials transport such as coal mining and cement manufacturing operations, and in medium and light weight applications such as light materials handling operations, package handling and transport, and the like. For certain lightweight applications, such as airport baggage handling, parcel/package handling and distribution center facilities, conveyor belts are required to operate below prescribed noise levels, to ensure a more comfortable and safe working environment.

Conventional lightweight belts, which often utilize a woven fabric to provide strength, are quite noisy due to the “washboard” interaction between the fabric weave and the conveyor rollers. Non-woven materials have been used with some success to provide a smoother interaction between the belt and the conveyor rollers. Since non-wovens by definition don't have a fabric “weave” the interaction between the belt and the conveyor structure is smoother. Additionally, non-woven materials provide some sound damping due to the substantial air volume contained between the fibers.

A disadvantage of traditional non-woven materials is that they have relatively low lateral and longitudinal strength, rendering them susceptible to longitudinal tearing and fastener pullout, and making them unsuitable for use alone as conveyor belt carcasses for a wide variety of applications. Additionally, belts incorporating woven scrim with multifilament weft yarns can only provide limited transverse rigidity because the yarns will naturally stretch. Belts with low transverse rigidity may have a tendency to curl or warp to an undesirable degree when subjected to high tensile forces imparted by the conveyor system.

Thus, there is a need for an increased strength low-noise conveyor belt design for use in a wide variety of low-noise conveying applications. Such an improved low-noise belt should provide low stretch, excellent fastener holding strength, increased resistance to tearing, and should have enhanced transverse rigidity to enable the belt to lay flat even when subjected to the high tensile forces imparted by the conveyor system.

### SUMMARY OF THE INVENTION

The disadvantages heretofore associated with the prior art are overcome by the inventive design for a conveyor belt having a needled felt design combined with a layer of fabric comprising monofilament weft fibers. The inventive design provides advantages including cost-effectiveness, efficiency and increased strength as compared to previous designs.

A low-noise conveyor belt is disclosed, comprising a woven layer, a non-woven layer, and an elastomer engaging the first and second non-woven layers. The woven layer may comprise monofilament weft fibers and multifilament warp fibers. The woven layer may comprise a plurality of woven layers engaged to each other by the elastomer, and the monofilament weft fibers of adjacent woven layers may be vertically offset from each other by a predetermined distance to provide the belt with a desired lateral stiffness.

The woven layer may comprise a plurality of monofilament weft layers, the monofilaments of adjacent layers being vertically offset from each other. The woven layer and the non woven layer may be fixed together by needling such that fibers of the non-woven layer interlock with at least some of the warp and weft fibers of the woven layer. The woven layer may further comprise multifilament weft fibers. The multifilament weft fibers may comprise a material that is different from the material of the monofilament weft fibers. The woven and non-woven layers further may be impregnated with the elastomer. The non-woven layer may comprise polyester, and the elastomer may comprise polychloroprene.

A conveyor belt structure is further disclosed, comprising a layer of non-woven material, a layer of woven material comprising monofilament weft fibers and multifilament warp fibers, and an elastomer in contact with the first and second layers to fix the layers together. The first layer of non-woven material may be needled to the layer of woven material so that at least some of the staple fibers are interlocked with at least some of the warp and weft fibers.

The layer of woven material may comprise a plurality of woven layers connected to each other by the elastomer such that monofilament weft fibers of adjacent woven layers are vertically offset from each other by a predetermined distance to provide the belt with a desired lateral stiffness. The layer of non-woven material and the layer of woven material may impregnated with the elastomer, and the elastomer may comprise polychloroprene.

The woven layer may be a weave selected from the list consisting of plain weave, twill weave, broken twill weave, leno weave, straight warp weave, crow foot weave, oxford weave, S-weave, and A-weave. Further, the layer of non-woven material may be impregnated with the elastomer and has a surface pattern embossed on an outer surface thereof. The layer of woven material may further comprise a plurality of multifilament weft fibers. The multifilament weft fibers may comprise a material that is different from the material of the monofilament weft fibers.

A method of making a conveyor belt structure is also disclosed, comprising: providing a non-woven layer; providing a woven layer have a plurality of monofilament weft fibers and a plurality of multifilament warp fibers; needling the first non-woven layer to the first woven layer; applying an elastomeric material to at least the woven layer; and curing the elastomeric material to lock the layers together. The step of providing a woven layer may comprise providing a plurality of woven layers. The step of applying an elastomeric material may comprise a calendering process.

The method may further comprise dipping the non-woven layer and the woven layer in resorcinol formaldehyde latex (RFL). Further, the first non-woven layer and the first woven layer may be provided in roll form, and the steps of disposing the first non-woven layer on the first woven layer and needling the first non-woven layer to the first woven layer may be performed by rolling out the layers and continuously feeding them into a needling apparatus.

The method may further comprise providing a second non-woven layer, the first and second non-woven layers being disposed on opposite surfaces of the first woven layer. The elastomeric compound may comprise polychloroprene. Further, the step of applying an elastomeric material may comprise submerging the woven layer and the non-woven layer in a bath of liquid elastomer. Alternatively, the step of applying an elastomeric material comprises an extrusion coating process.

### BRIEF DESCRIPTION OF THE DRAWINGS

The details of the invention, both as to its structure and operation, may be obtained by a review of the accompanying drawings, in which like reference numerals refer to like parts, and in which:

FIG. 1. is an isometric cutaway view of an exemplary conveyor belt employing the inventive carcass structure;

FIG. 2 is a detail cutaway view of the conveyor belt of FIG. 1;

FIG. 3 is a partial cross-sectional view of an exemplary weave pattern for use as the woven layer in the conveyor belt of FIG. 1;

FIG. 4 is a detail cutaway view of an alternative embodiment of the conveyor belt of FIG. 1, incorporating a cover layer on one side of the belt;

FIG. 5 is an isometric view of a first non-woven material layer for use in the carcass structure of FIG. 1;

FIG. 6 is an isometric view of a first monofilament woven layer for use in the carcass structure of FIG. 1;

FIG. 7 is a detail plan view of the woven layer of FIG. 6 showing an exemplary monofilament weft and multifilament warp weave structure;

FIGS. 8A and 8B are plan and cross section views, respectively, of a splice joint for use with the conveyor belt of FIG. 1;

FIG. 9 is a schematic view of a system for continuously manufacturing the carcass structure of FIG. 1.

### DETAILED DESCRIPTION

A new conveyor belt design is disclosed for low-noise applications in which enhanced lateral stiffness and strength is desired. The belt design employs a carcass integrating one or more layers of non-woven material with a layer of fabric. The monofilaments of the fabric are oriented so that they lie in the transverse (i.e., weft) direction of the finished belt, thus providing the belt with enhanced transverse rigidity, enabling the belt to lay flat and enhancing its longitudinal tear resistance. The weft monofilaments also provide increased resistance to fastener pullout. The non-woven layer or layers provide the belt with desired low-noise characteristics during operation.

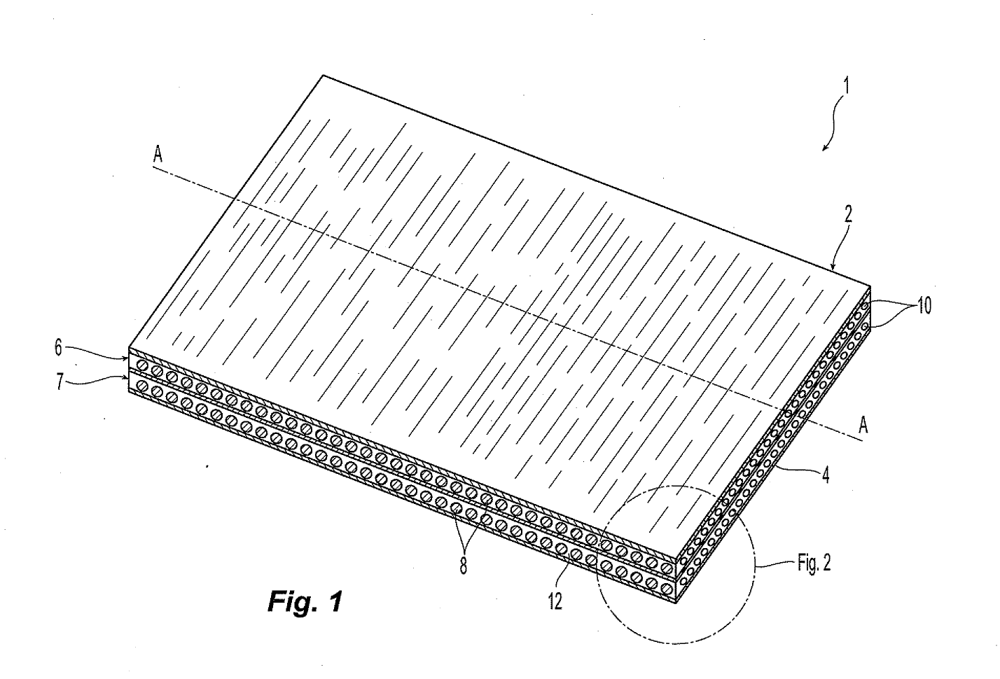

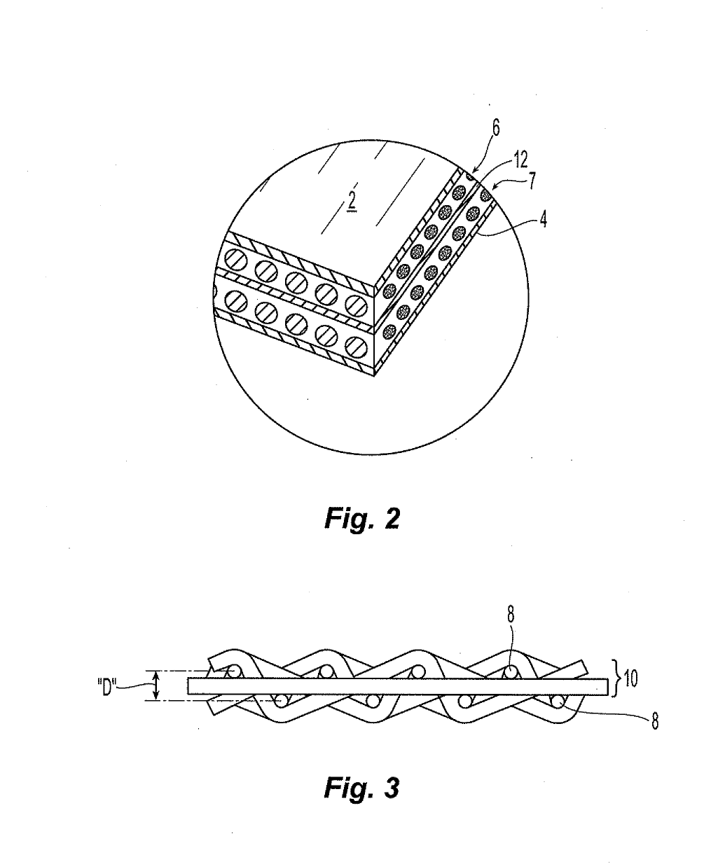

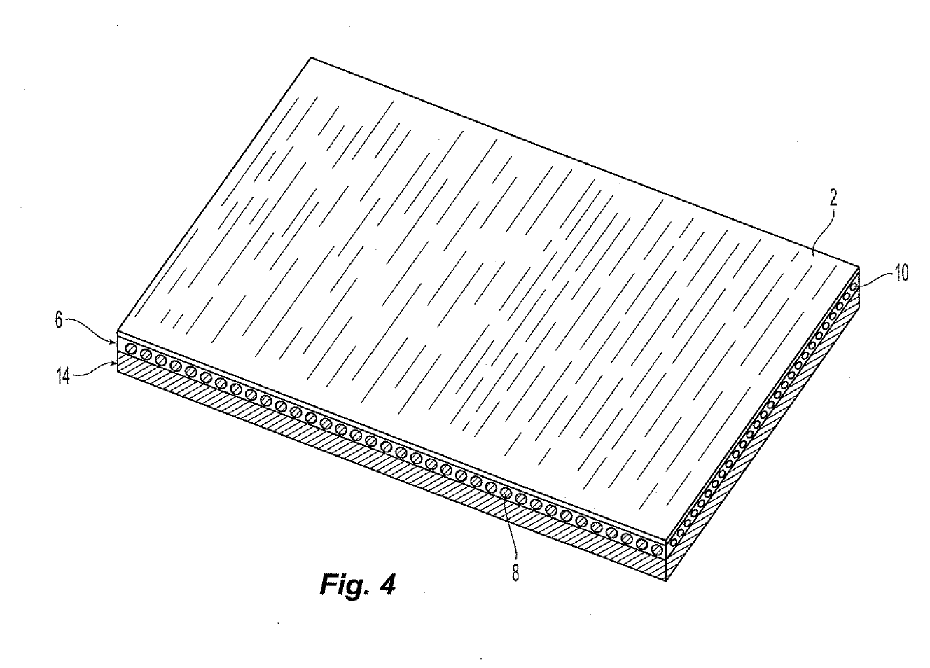

Referring to FIGS. 1 and 2, a cross-section of an exemplary multi-layer conveyor belt 1 is shown having first and second non-woven layers 2, 4, and first and second woven layers 6, 7. Each of the woven layers 6, 7 may have an associated non-woven layer 2, 4 attached to one side thereof using, for example, a needling process that locks a portion of the staple fibers of the non-woven layer 2 or 4 to the weft 8 and warp 10 filaments of the respective woven layer 6 or 7. The conveyor belt 1 may further comprise elastomeric material 12 that bonds the woven layers 6, 7 together. The elastomeric material 12 may at least partially saturates the layers 2, 4, 6, 7 and serve to bond all of the layers (as well as the individual fibers make up each layer) together to form a solid yet flexible finished structure. In some embodiments the elastomeric material 12 may be applied in sufficient thickness to form a cover layer 14 on one side of the conveyor 1 (see FIG. 4). In other embodiments, such as the one described in relation to FIGS. 1 and 2, the elastomeric material 12 may saturate the layers 2, 4, 6, 7 but does not form a discernable “cover” layer. As will be appreciated, combinations of layers may be fabricated to construct a finished belt having a desired set of properties such has high strength, low running noise level and the like.

In a preferred embodiment, the first and second non-woven layers 2, 4 comprise staple polyester non-woven felt material, the reinforcing layers 6, 7 each comprise a woven fabric containing monofilament weft strands and multifilament warp strands, and the elastomeric material 12 comprises polychloroprene (commonly sold under the trade name Neoprene™).

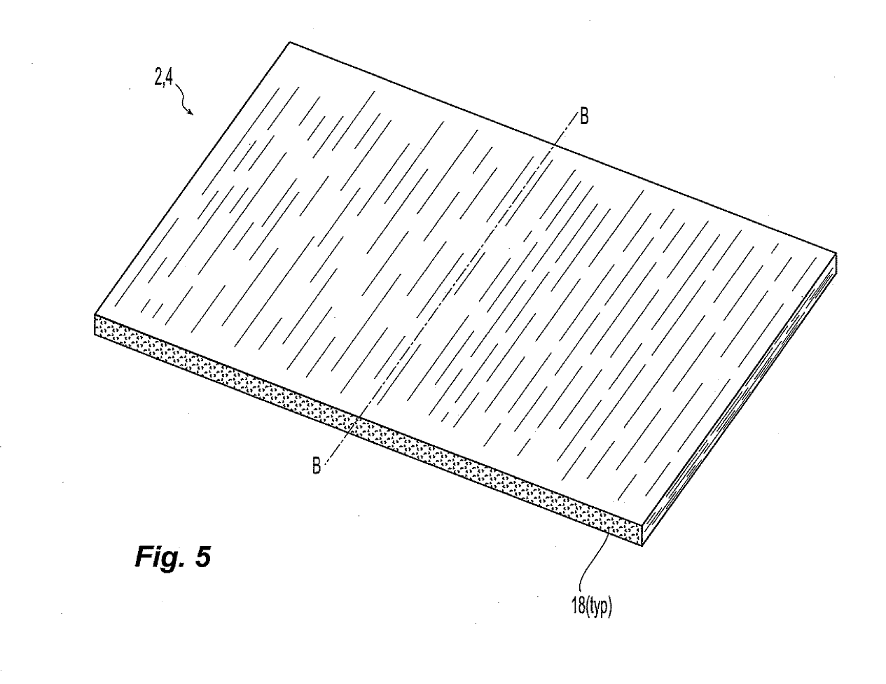

Referring now to FIG. 5, one of the non-woven layers 2, 4 is shown prior to its application to one of the woven layers 6, 7. In the illustrated embodiment, the non-woven layer has a plurality of staple fibers 18 aligned substantially parallel to the lateral axis B-B of the non-woven layer 2, 4. When assembled with one of the woven layers 6, 7 to form a conveyor belt 1, this lateral axis B-B will be oriented substantially perpendicular to longitudinal axis A-A (FIG. 1) of the finished belt 1.

Although the illustrated embodiment shows the staple fibers 18 aligned along axis B-B, it will be appreciated that the staple fibers in non-woven layers 2, 4 may have other orientations as well. Thus, the staple fibers 18 may be oriented substantially parallel with the longitudinal axis A-A of the finished belt 1. Alternatively, a portion of the staple fibers 18 may be oriented parallel to axis A-A and a second portion of the staple fibers 18 may be oriented parallel to axis B-B. Furthermore, the non-woven layers 2, 4 may have the same, or different, staple fiber orientations.

The first and second non-woven layers 2, 4 may comprise any appropriate non-woven material, which in one exemplary embodiment is a pressed polyester felt material composed of multidirectional staple fibers 18. Left in an uncarded, unneedled state, these non-woven layers 2, 4 would have very low strength in both the lateral and longitudinal direction and would be unsuitable for use as structural layers in a conveyor belt. Thus, to enhance the strength of these layers, a carding process may be performed to align the staple fibers 18 of the non-woven layers 2, 4 in a desired direction. Subsequent to carding, the individual non-woven layers 2, 4 may be compressed by passing them through a series of press rollers having progressively smaller clearances. The compressed layers may then be directed through a needling stage to lock the aligned fibers 18 together and to compress the individual layers into a tighter, thinner and more dense, configuration. Formed in this manner, the non-woven layers achieve a level of strength in the direction of fiber alignment that they did not possess prior to carding or needling.

Needling also serves to preserve the dimensional stability and structural integrity of the carded first and second layers 2, 4 during handling or when they are subjected to processing forces oriented perpendicular to the direction of fiber alignment. In the absence of needling, the tensile strength of the laterally carded non-woven layers 2, 4 may be so low that the layers 2, 4 are susceptible to being damaged (e.g., pulled apart) during handling or when forces from the processing apparatus are applied during subsequent manufacturing steps. The specific techniques of needling non-woven materials are well known to those of skill in the art, and thus they will not be described in detail.

The first and second non-woven layers 2, 4 may be formed into batts of discrete lengths, or they may be formed into continuous layers and rolled for storage, awaiting further processing. Alternatively, when the first and second non-woven layers 2, 4 are manufactured as part of a continuous conveyor belt manufacturing process, they may each be continuously formed (i.e., combed/carded/needled) and then fed directly to one or more needling stages for application to an associated woven layer 6, 7.

Once the non-woven layers 2, 4 have been needled to the respective woven layer 6, 7 the combined layers may be rolled up and stored for later fabrication into a finished conveyor belt 1, or they may be immediately directed to elastomer application and finishing stages. In some applications, no additional processing steps may be required, and thus a finished conveyor belt may comprise first and second non-woven layers 2, 4 and one or more woven layers 6, 7, with no elastomeric component 12. It will be appreciated, however, that it will usually be desirable to include an elastomeric component, since the elastomer that provides enhanced cohesion, strength and long-term stability to the finished conveyor belt 1.

Additionally, where two or more woven layers 6, 7 are provided, the elastomeric component 12 serves to separate the monofilament wefts 8 of the adjacent woven layers 6, 7. Although the woven layers 6, 7 including the monofilaments 8 will individually have some inherent degree of lateral stiffness, substantially higher stiffness is gained by using multiple monofilament layers separated by a layer of elastomeric material 12 (see FIG. 2). By separating the woven layers 6, 7, the monofilaments 8 of the adjacent woven layers 6, 7 in concert with the intervening elastomer 12 create a structural “beam” arrangement that substantially enhances the lateral strength and stiffness of the finished belt.

This same “beam” effect may alternatively be obtained in a single-ply configuration by using a woven layer with a weave pattern that itself “stacks” the monofilament wefts within the layer. An example of such a weave pattern is shown in FIG. 3, which illustrates an “A2” type weave, in which two layers of monofilament wefts 8 are vertically separated by a distance “D” by warp multi-filaments 10. When impregnated with the elastomeric component 12, a similar “beam” arrangement is created that may provide the finished belt 1 with sufficient stiffness that a single ply of woven material 6 is sufficient.

A variety of characteristics of the individual non-woven layers 2, 4 may be adjusted to change the properties of the finished conveyor belt 1. Thus, staple fiber material type, staple fiber dimensions (length, denier), needling density, needle size, type, orientation and depth of needle penetration, all can be selected for each non-woven layer 2, 4 to provide desired finished properties of conveyor belt 1. A high degree of smoothness may be desirable to maximize the low-noise properties of the belt 1, and thus the needling process may be specified accordingly to achieve such smoothness.

For belts 1 in which two non-woven layers 2, 4 are used, the two layers may contain different staple fiber materials, lengths, and deniers, or combinations thereof. The two layers also may be subjected to different numbers and types of carding and needling processes depending on the smoothness or layer thickness/density desired for each layer. And as previously noted, the layers 2, 4 may also be carded to align their fibers in either the same or different directions.

In one embodiment, the side of the belt 1 that is in contact with the conveyor mechanism may have a relatively small thickness of non-woven material in order to minimize noise and friction, while the opposite side of the belt 1 (i.e., the side that will be in contact with the product being handled by the conveyor system) may have a thicker non-woven layer in order to provide a high degree of abuse-resistance. This thicker non-woven layer may also be saturated with the elastomeric material 12 to provide even greater abuse resistance.

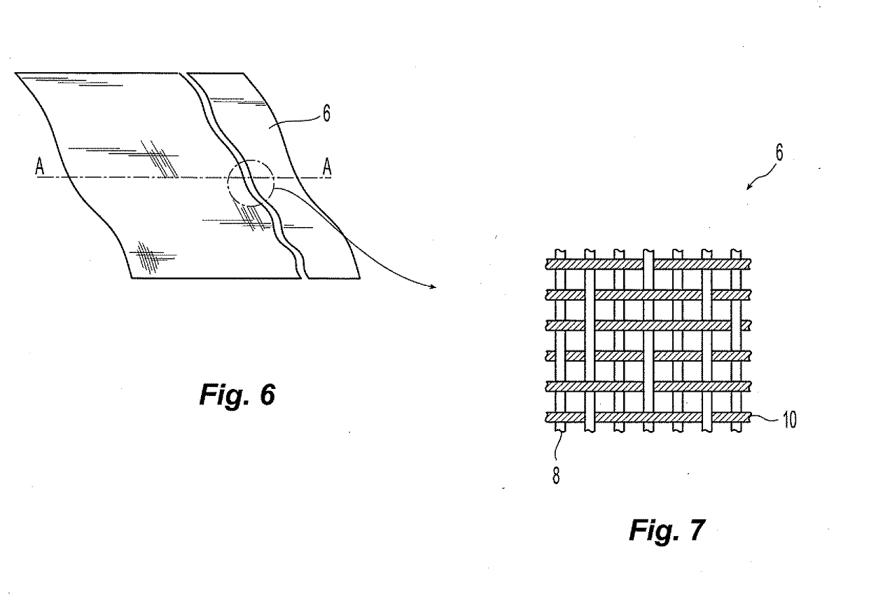

Referring to FIGS. 6 and 7, the woven-layer 6 will now be described in greater detail. It is noted that although the following discussion will refer to the first woven layer 6 only, the description is equally applicable to the second woven layer 7. As previously noted, woven layer 6 may comprise a woven fabric having a monofilament weft 8 configuration. The warp fibers 10 may be multifilament strands. During conveyor belt manufacture, the woven layer 6 will be oriented so that the warp fibers 10 are substantially aligned with the longitudinal axis A-A of the belt 1. As such, the weft monofilaments 8 of the layer 6 will be oriented substantially perpendicular to the longitudinal axis A-A to provide the desired lateral strength and stiffness to the finished belt 1.

The warp fibers 10 may comprise any of a variety of multi-filament structures. In one-embodiment, the warp fibers 10 may comprise an alternate twist plied yarn (i.e., yarn having alternating “S” twist segments and “Z” twist segments) as described in U.S. Patent Application Publication No. 2004-0050031 to Gilbos et al., titled “Yarn Package,” and filed Dec. 21, 2001, the entirety of which application is incorporated by reference herein. Alternatively, the warp fibers 10 may individually comprise “S” or “Z” twist yarns. In one embodiment, the warp fibers 10 of the woven layer 6 may not all be of the same design (size, twist, material, number of strands, etc.). For example, some of the warp fibers 10 of the woven layer 6 may have an “S” twist configurations while other warp fibers 10 of the same woven layer may have a “Z” twist configuration. Additionally, the warp fibers 10 of the first woven layer 6 may be the same or different from the warp fibers 10 of the second woven layer 7.

The weft monofilaments 8 may comprise any of a variety of sized monofilament structures. It is also contemplated that the wefts may comprise alternating mono and multi-filaments to provide a controlled degree of lateral stiffness. In addition, the wefts may comprise alternating polymer types, such as polyester, nylon, glass, and the like. Thus, adjacent wefts can comprise alternating mono- and multi-filaments and/or alternating material types, to provide a finished belt 1 having the desired stiffness characteristics. In one non-limiting exemplary example, three polyester monofilaments could be alternated with 6 glass multifilaments, with this pattern continually repeated throughout the belt weave.

The embodiment illustrated in FIG. 6 shows the woven layer 6 having a plain weave configuration with monofilament wefts 8 and multifilament warps 10. It will be appreciated, however, that the woven layer 6 may be provided in any of a variety of weave styles, including plain weave, twill, broken twill, leno, straight warp, crow foot weave, oxford weave, S-weave, A-weave and the like. Woven fabric (or scrim) weave pattern possibilities could cover a wide range. In one embodiment, the weave configuration is plain weave, and finds particular applicability to belts having multiple woven layer plies. However, a plain weave woven layer 6 may be combined with special weave patterns like a broken twill pattern.

One advantage of providing a woven layer with only weft-wise monofilaments (as opposed to having monofilament weft and warp) is that it may facilitate the process of needling the non-woven layers 2, 4 to the woven layers 6, 7. Since the monofilaments are typically more rigid than multifilament fibers, they may interfere with the needles and needle barbs when the non-woven layers 2, 4 are being needled to the woven layers 6, which can result in needle breakage, monofilament breakage, or both. Thus, providing a woven layer having monofilaments in only the weft direction reduces the chance for damage to the equipment and the fabric, while still providing substantial lateral strength improvements for the finished conveyor belt 1.

It is noted that a variety of combinations of woven and non-woven plies can be used to form a finished conveyor belt according to the invention. Thus, although the embodiment illustrated in FIGS. 1 and 2 show a carcass 9 including two non-woven layers 2, 4 and two plies of woven material 6, 7, various alternative ply arrangements may also be provided. For example, the carcass 9 may comprise a pair of non-woven layers 2, 4, each needled to respective opposite side of a single woven layer 6. Alternatively, as illustrated in FIG. 4, the carcass 9 may comprise a pair of woven layers 6, 7, with only one non-woven layer 2 needled to the first woven layer 6. The second woven layer 7 may have an elastomeric cover applied, without an intervening non-woven layer. Additionally, a carcass having three or plies of woven material could be constructed, with the outer plies either having an associated non-woven layer needled thereto, or an elastomeric cover. These are but a few examples, and it will be understood that a variety of others are possible without departing from the spirit of the invention. For multi-ply carcass configurations, the individual woven plies 6, 7 may have the same weave pattern, or they may have different weave patterns. These weave patterns may incorporate a variety of configurations of multi- and mono-filaments, including weaves in which the weft filaments alternate between mono- and multi-filaments. In addition to different weave styles, the individual plies may have different warp/weft material, fabric weights, etc.

Once the first and second non-woven layers 2, 4 have been formed, layered, and needled-to the woven layers 6, 7 (again, assuming an embodiment in which both woven layers will have a respective non-woven layer applied), the resulting carcass 9 may then be immersed in, or spray coated with, an adhesion promoter such as resorcinol formaldehyde latex (RFL). After curing of the adhesion promoter (such as by heating), elastomeric material 12 may be applied to form the finished belt 1. A variety of techniques may be used to apply the elastomeric material, including dipping or calendaring, or combinations thereof. Typically, a dipping process in which the layers 2, 4, 6, 7 are submerged in a liquid elastomer will be sufficient to achieve a desired level of impregnation of the carcass with the elastomer. As previously noted, the elastomer (and its application process) can be important factors in achieving a desired belt strength and integrity because the elastomer serves to lock the layers 2, 4, 6, 7 together when cured, thus preventing the layers from delaminating over the lifetime of the belt 1. In some instances, it may be desirable to apply a vacuum or other appropriate technique to facilitate impregnation of the carcass with the elastomer. Alternatively, dipping coupled with agitation such as by passing the belt 1 through a squeegee/roller system. As noted, calendaring may also be used, in combination with dipping/agitation to ensure the elastomeric material 12 penetrates the fibers of the layers 2, 4, 6, 7.

The elastomer application process may also be adjusted to customize the degree of penetration of the elastomer 12 into the first and second non-woven layers 2, 4, and also to control the thickness of the covering layer(s) 14 if such layer(s) are applied. This may be important because the type of elastomer and the degree of penetration of the elastomer within the carcass are expected to affect the ultimate strength of the finished belt.

Other elastomer application techniques may also be employed as desired and depending on the type of elastomer compound used. Such techniques can be used to impregnate the belt carcass 9 with elastomer, or they may be used to apply an elastomeric cover layer 14 to one side of the belt 1. In one non-limiting example, where an elastomer cover layer 14 is applied to one or both exterior surfaces of the woven layer or layers 6, 7, a calendering process may be employed to form such covers. As previously noted, where an elastomer cover layer 14 is applied to the woven layer(s), an associated non-woven layer 2, 4 will typically not be applied.

Combinations of cover application processes may also be used. For example, the carcass 9 may first be dipped into a first elastomer and cured, and then one or more cover layers 14 may be calendered onto the carcass 9 using a second elastomer. The first and second elastomers may be of substantially the same formulation, or they may be different formulations.

Additionally, it will be appreciated that in addition to calendering, a variety of other processes can also be used to apply the cover(s), such as dipping, knife coating, or extrusion coating.

The aforementioned elastomer applications can be used to obtain a finished conveyor belt 1 having a desired surface configuration that either leaves a portion of the non-woven layer exposed, or provides an encapsulating elastomeric cover layer 14 on one side of one of the woven layer 6, 7. For embodiments in which the carcass 9 is formed with one or more non-woven layers 2, 4 and impregnated with an elastomer material 12, a portion of the exterior surfaces of the non-woven layers 2, 4 may remain exposed. In such cases, the non-woven layers 2, 4 may be “singed” to melt the outer surface of the non-woven material layers, locking them together and preventing the surface from “fuzzing” on the surface, thus enhancing the smoothness of the surface finish, thus reducing rolling friction and attendant noise. Additionally, the exposed non-woven surfaces may be ground to enhance their smoothness.

For embodiments in which the carcass 9 is dipped in the elastomeric material 12 so that the elastomer will penetrate only some of the layers 2, 4, 6, 7, one side of the carcass 9 may be saturated with elastomer 12 and the other side may be left bare (i.e., the surface of the non-woven layer will be exposed and not saturated in elastomer).

With embodiments such as that illustrated in FIG. 4, in which the belt 1 is provided with at least one cover 14, the cover 14 may be customized to provide an enhanced coefficient of friction for engagement with the conveyed material. For example, surface finishes (smooth, or semi-smooth) may be achieved by passing the belt 1 through a smooth or lightly-textured calender roll. To provide a high textured surface, a rigid mold (e.g., metal platen), a flexible pressure pad or an impression fabric can be used. In one exemplary embodiment, when PVC material is used as the elastomeric component 12, a surface finish may be embossed into the non-woven material 2, 4. This is achieved by exposing the elastomer-saturated non-woven surface with high-intensity heat to soften it, and then directing it through calender rolls having a design engraved in the roll to provide the desired surface texture.

Such surface texturing may be of particular advantageous where the conveyed material is being carried up an incline. Furthermore, the cover(s) 14 and/or exposed non-woven layer(s) 2, 4 may have a physical profile embossed or otherwise formed into their surfaces to give them increased “grip” on the conveyed material.

For those embodiments in which top and/or bottom covers 14 are desired, they may be formed of the same elastomeric material 12 used to impregnate the carcass 9, or they may be made from a different elastomer compound. Additionally, if both top and bottom covers are used, they may be made from different compounds and have different additives, and/or may have different surface finishes applied. This may be advantageous where a smooth surface finish is desired for the bottom surface (the one that will be in contact with the conveyor pulleys and rollers during operation) while providing a rougher finish on the top to provide good retention/holding of the materials being carried by the conveyor. It may also be desirable where heat resistance is needed for the top cover, but is unnecessary for the bottom cover.

In one embodiment, for package handling or luggage handling operations, the belt 1 may have an exposed non-woven surface on the bottom side for interaction with the pulleys and rollers of the conveyor system. In such instances, the non-woven surface may be subjected to a grinding operation to remove protruding fibers and provide an even smoother surface finish. The first and second non-woven layers 2, 4 may also be singed prior to application of the elastomeric material 6.

Any of a variety of natural or synthetic elastomeric materials suitable for conveyor belt applications may be used as the elastomeric material 12. A non-limiting list of exemplary materials includes chlorosulfonyl-polyetheylene (e.g. Hypalon®), polyethylene terephthalase (e.g., Hytrel®), natural rubber, chloroprene, polychloroprene (e.g, Nitrile®), nitrile-butadiene rubber, butadiene rubber, isoprene, styrene-butadiene, modified polysiloxanes, polyester urethane, polyether urethane, polyvinyl chloride, fluorocarbon polymers, ethylene propylene rubber (EPR), and the like. In a preferred embodiment, the elastomeric material comprises polychloroprene. Additionally, different combinations of elastomers may be used within a single belt. For example, it may be desirable to use a first elastomer (e.g., PVC) to impregnate the carcass, and a second elastomer (e.g., Nitrile) to form the cover.

The elastomeric material 12 may also comprise additives for enhancing flame retardancy, wear and chunk resistance, rolling resistance, aging resistance (e.g., ozone and UV resistance), and the like. Vulcanization aids, cross-linking agents, oils, accelerators, or other formation aids may also be used as appropriate.

The first and second non-woven layers 2, 4 may be formed from any of a variety of materials, including a wide variety of synthetic and natural fibers, such as polyester, nylon, aramid (e.g., Kevlar®), glass, polypropylene, cellulose, wool, or others.

Additionally, a variety of individual fiber sizes may be selected for the first and second nonwoven layers 2, 4. The individual fibers may be from about 1 denier to about 6 denier, and may be from about 1-inch to about 6-inches in length, with 3 inches length and 3-4 denier being preferable. The denier and length of the fibers used to form the nonwoven layers 2, 4 may each be selected to yield desired strength properties for the final conveyor belt 1. For example, a 2 denier fiber could be provided in a 3 inch length, or a 4 denier fiber could be provided in a 3 inch length. Additionally, the denier of the fiber may be selected to provide a desired final surface texture for the carcass and/or the finished belt (i.e., a finer denier generally resulting in a softer final surface of the carcass). In one embodiment, the first and second nonwoven layers 2, 4 are made from staple polyester nonwoven felt material comprising 3 denier, 3-inch long staple fibers.

The woven layers 6, 7 may be formed from a variety of synthetic and/or natural fibers materials in any of a variety of weaves, as long as the wefts comprise monofilaments 8 and the warps are multifilaments 10. Examples of appropriate materials include polyester, nylon, aramid (e.g., Kevlar®), glass, polypropylene, cellulose, wool, and the like. Additionally, the warp and weft filaments 8, 10 of the woven layers 6, 7 may be made from the same material, or they may be made from different materials. For example, the first woven layer 6 may comprise polyester, the second woven layer 7 may comprise glass, and a third woven layer may comprise aramid.

The warp and weft filaments 8,10 also may be provided in a variety of sizes, depending on the particular application. The weft mono-filaments may be from about 100 denier to about 70,000 denier (i.e., about 0.11 mm to about 2.5 mm). The warp filaments 10 may be from about 200 denier (fine thread) to about 1680 denier (bundle size). Further, the warp multi-filaments may be “built up” from multiple smaller filaments. For example, a warp multifilament may comprise a 1000 denier “bundle” having a filament count of 198. Alternatively, a 1300 denier bundle having a 100 filament count could be used. As will be appreciated, a variety of filament sizes and counts can be used to provide a desired strength and wear resistance for the finished belt 1.

In one exemplary embodiment, the weft filaments comprise 0.3 millimeter diameter polyethylene terephthalate (PET), while the warp yarns comprise 1300 denier polyester with an S/Z twist.

The woven layers 6, 7 may be provided in a variety of fabric weights, depending on the application. For light package handling operations, the layers may be about 5-6 ounces per square yard (ospy), while for heavy package handling operations and/or conveyors with very long straight belting runs the layers may each be up to as much as 1000 ospy.

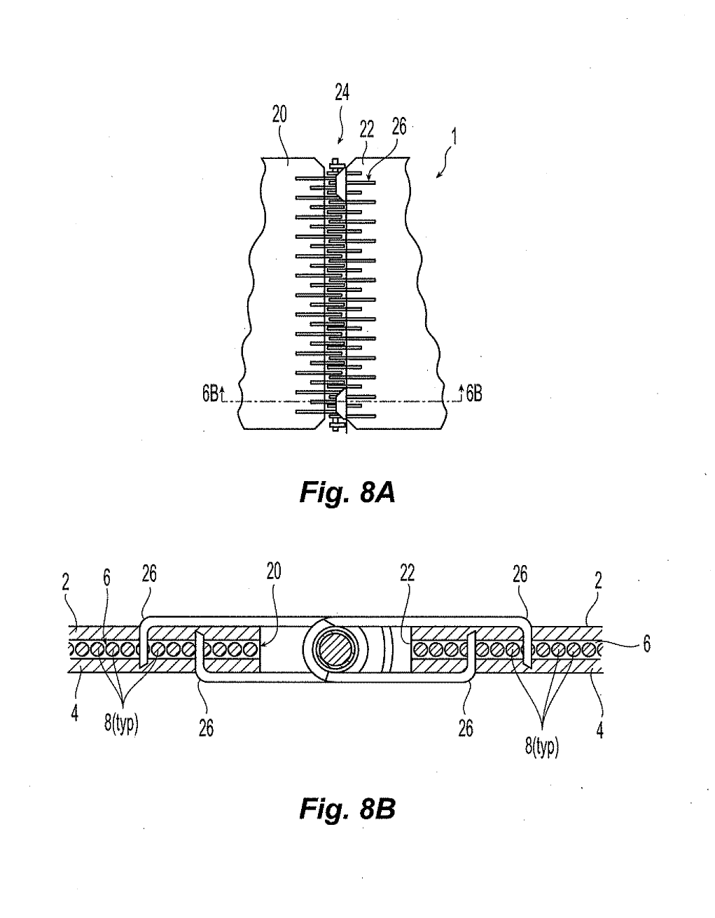

An exemplary belt splice joint is shown in FIGS. 8A and 8B, illustrating the orientation of the monofilament wefts 8 for opposing pullout in response to a force applied by the-splice joint laces. In the illustrated embodiment, a single reinforcing layer 6 can be seen comprising a plurality of monofilament wefts 8, each having an axis substantially perpendicular to the longitudinal axis A-A of the belt 1. The splice joint 24 comprises a series of laces 26 that penetrate the carcass 9 to hold the opposing ends 20, 22 of the belt 1 in close relation. During operation, high pullout forces transmitted by the laces 26 may cause belts to break or may cause the fibers of the individual carcass layers to pull apart, resulting in shortened belt life or failure. To combat this, the monofilament weft fibers 8 of the woven layer 6 are oriented to provide substantial resistance to pullout of the fastener laces 26, thus providing a high integrity splice joint 24 that resists breakage and/or layer separation during operation. The monofilament wefts 8 are aided in this function by the staple fibers 18 of the non-woven layer(s) 2, 4, which, as a result of being needled to the woven layer(s), lock the warps 10 and wefts 8 in place. This locking serves to further enhance the fastener pull-out resistance.

A substantial advantage of the disclosed belt design is that it is amenable to manufacture using a continuous process, which can reduce the cost of production in terms of both time and manpower. A method for continuous manufacturing of a preferred embodiment of the conveyor belt 1 begins with the formation of the first and second non-woven layers 2, 4 from bulk staple fiber material. The staple fibers are carded, pressed and needled to form batts of non-woven material having desired physical characteristics of thickness, density and strength. The non-woven layers are then needled to opposite surfaces of the woven layer 6 to form a carcass structure 7. The carcass 9 may be treated with an adhesion promoting material 42 (such as RFL), and then dipped into a bath of liquid elastomeric material 12. The elastomer-coated carcass may then be cured and pressed, and top and bottom cover layers 14, 16 formed, if desired.

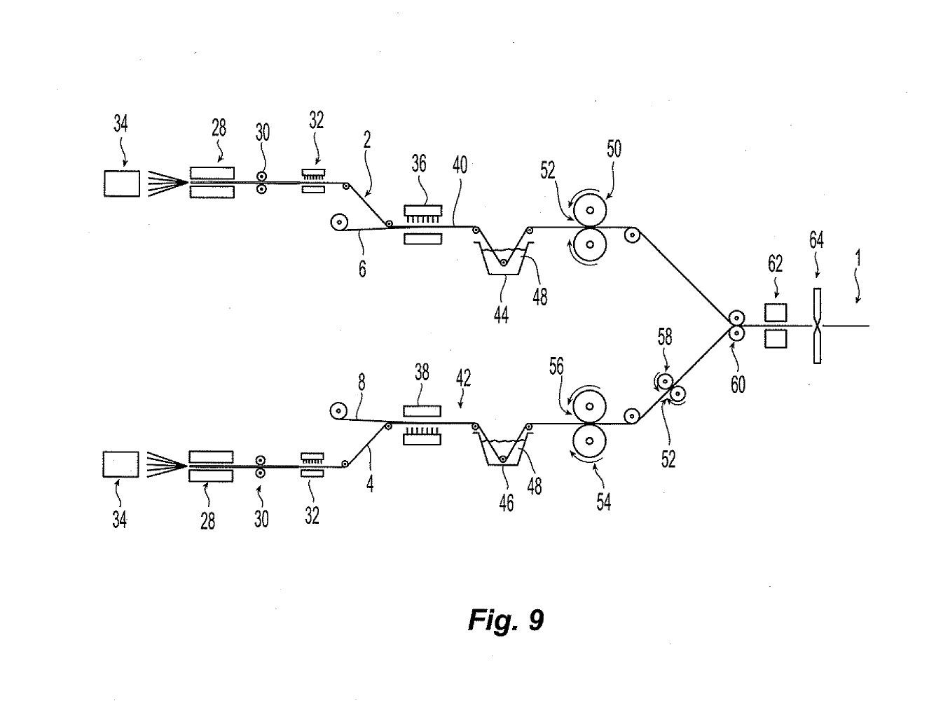

Referring to FIG. 9, the continuous manufacturing process will be described in greater detail. The first and second non-woven layers 2, 4 may be formed from what initially consist of bales of bulk staple fibers 34. The bales are fluffed and combed, then fed through an air chamber to separate the individual fibers. The fibers are then carded 28 to align the staple fibers 18 in a desired direction with respect to the longitudinal axis of the conveyor belt 1. In on embodiment, carding aligns the staple fibers 18 in the lateral direction (i.e., transverse to the longitudinal axis of the belt, and parallel to axis B-B of FIG. 5) for both of the layers 2, 4. The carded layers 2, 4 may then be subjected to one or more squeeze roller stages 30 to squeeze/compress and tack the individual carded material layers together. The compressed layers 2, 4 may then be needled 32 to further compress the layers and provide them with an increased degree of structural stability. The needled layers 2, 4 may then be directed to a second needling stage 36, 38 which tacks them to their associated woven layer 6, 8.

In an alternative embodiment, the needled layers 2, 4 are not immediately applied to respective woven layers, but instead might be cut to size and rolled for storage. Thus, it would be possible to manufacture the non-woven layers ahead of time, and to store them for later use.

The amount of needling (i.e., needle density, depth of penetration, number of discrete needling stages, etc.) represented by stages 36 and 38 should be selected to be just sufficient to provide a minimum level of adhesion between the layers so that they remain in tight contact while the elastomer 12 is applied. In one non-limiting embodiment, the first and second non-woven layers 2, 4 are needled to the woven layers 6, 8 such that the adhesive force between the respective woven and nonwoven layers is about 10 pounds per inch width.

It is noted that although the layers 2, 4 are illustrated as each being subjected to only a single individual needling step 32 prior to their application to the woven layer 6, the individual layers 2, 4 may instead be subjected to multiple needling steps to achieve the desired thickness, density and smoothness of each layer 2, 4. Similarly, each non-woven layer 2, 4 may be subjected to multiple needling steps (in lieu of the single steps 36, 38 illustrated in FIG. 9) to attach the layers to the respective woven layer 6, 8.

The resulting carcass plies 40, 42 may then be directed to an elastomer pretreatment stage 44, 46, which in one embodiment comprises an RFL dip, to apply a thin coating of latex adhesive 48 to the plies. The elastomer pretreatment may facilitate bonding between the plies 40, 42 and the subsequently-applied elastomeric component, and also to help lock the weave (the woven and non-woven material) together. The first carcass ply 40 may then be directed through a calendaring stage 50 in which the elastomeric component 52 may applied to the non-woven side of the ply 40. The second carcass ply 42 may also be directed through a calendering stage 54 to provide a top cover elastomer 56, and then through a subsequent calendering stage 58 to have the elastomeric component 52 applied to the opposite side. The carcass plies 40, 42 along with their associated elastomeric components may then be combined at the entrance nip rollers 60 of a continuous curing stage 62. Subsequent to curing, the finished belt 1 may be cut to length at knife stage 64.

In an alternative embodiment, the carcass plies 40, 42 may be combined during the last rubber calendering stage 58 rather than at the nip rollers 60.

During the curing stage 62, a surface texturing may be applied to the top cover. In one embodiment, a “liner impression fabric” (not shown) may be cured against the cover rubber. The liner impression fabric may be a lightweight plain weave fabric, whose primary use is to make a negative impression on the surface of the elastomeric compound.

In the illustrated embodiment, the bottom felted side may be cured against a smooth surface. In both processes, the product is cured under pressure with heat for the time necessary to achieve optimum cure, then, removed and the liner impression fabric separated leaving a very light rough texture pattern in the top cover rubber and a smooth low friction felted bottom finish. To prevent sticking, the liner impression fabric may be treated with a release agent.

The above is a description of a method for building one exemplary belt, and other belt constructions, using different polymers, may be manufactured using different processes. For example, where the elastomeric compound 12 is PVC, the elastomer may be dip coated. Alternatively, a knife over roll coating type process may be used, combining rolls for building the plies and a extrusion process for the top cover, and a embossing station for the cover profile.

Where a dip coating process is employed, each ply 40, 42 would be coated with a thermoplastic elastomer (e.g., plastisol) using a knife coating process, and the two plies would then be combined either while they are still wet, or after they have fused by re-melting the thermoplastic.

It may also be desirable to use an extruded film to join the plies 40, 42 together. In such an embodiment, an thermoplastic layer may be extruded between the plies 40, 42 just prior to feeding them into a nip roller.

As noted above, it may be desirable to impart specific finishes to the top and bottom surfaces of the belt 1. In addition to the liner impression fabric technique discussed previously, an embossed finishing roll may be used to apply a desired surface finish or configuration to one side of the belt. Embossing could also be performed directly on the exposed non-woven surface by applying sufficient heat (e.g., from a radiant heat source) to the surface of the nonwoven layer(s) 2, 4 to soften the staple fibers 18 (and the elastomeric material 12) and then immediately passing the carcass 9 through an embossed finishing roller. Once cooled, the surface of the non-woven layer will retain the embossed shape.

If the belt 1 is provided with additional reinforcement layers, such layers may be applied at any of a number of stages in the manufacturing process. For example, a single reinforcing layer could be needled to each of the first and second non-woven layers 2, 4, after the non-woven layers 2, 4 have been carded. The non-woven layers 2, 4 (with associated reinforcing layers) could then be needled to the woven layer(s) 6, 7.

Although the manufacturing process has been described as a series of immediately successive process steps, such continuous progression of process steps is not critical. Thus, for example, it may be feasible and desirable to individually card, press and needle the first and second non-woven layers 2, 4 and then store them in roll form (or ship them to another location) to await subsequent processing steps. Likewise, it may be desirable to needle the first and second non-woven layers 2, 4 to the woven layer 6, and then to roll up the carcass 9 to await further processing.

### EXAMPLE 1

A conveyor belt was constructed from two layers of non-woven material, and a core layer of woven scrim. The first non-woven layer was a 5 ounce per square yard (opsy) 100% non-woven polyester material, while the second non-woven layer was a 1 opsy 100% non-woven polyester material. The polyester staple fibers of the non-woven material layers were 4 denier×3-inch long. Both non-woven layers were laterally carded. The woven scrim was a 10.5 opsy plain weave fabric having 1300 denier 1-ply polyester warp yarns having an S/Z twist, and 900 denier PET weft monofilaments. The non-woven layers were needled to the woven scrim to achieve maximum smoothness, while maintaining an optimum adhesion level. The first non-woven layer was singed.

The assembled layers comprised a 27 mil thickness of the first non-woven layer, a 23 mil thickness of woven scrim, and a 6 mil thickness of the second non-woven layer. The resulting carcass was RFL treated and cured, and a 125 mil cover layer of synthetic rubber compound.

It will be understood that the description and drawings presented herein represent an embodiment of the invention, and are therefore merely representative of the subject matter that is broadly contemplated by the invention. It will be further understood that the scope of the present invention encompasses other embodiments that may become obvious to those skilled in the art, and that the scope of the invention is accordingly limited by nothing other than the appended claims.

1. A low-noise conveyor belt, comprising:
a woven layer;
a non-woven layer; and
an elastomer engaging the first and second non-woven layers;
wherein the woven layer comprises monofilament weft fibers and multifilament warp fibers.

2. The low-noise conveyor belt of claim 1, wherein the woven layer comprises a plurality of woven layers, the plurality of woven layers being engaged to each other by the elastomer, and the monofilament weft fibers of adjacent woven layers are vertically offset from each other by a predetermined distance to provide the belt with a desired lateral stiffness.

3. The low-noise conveyor belt of claim 1, wherein the woven layer comprises a plurality of monofilament weft layers, the monofilaments of adjacent layers being vertically offset from each other.

4. The low-noise conveyor belt of claim 1, wherein the woven layer and the non woven layer are fixed together by needling such that fibers of the non-woven layer interlock with at least some of the warp and weft fibers of the woven layer.

5. The low-noise conveyor belt of claim 1, wherein the woven layer further comprises multifilament weft fibers.

6. The low-noise conveyor belt of claim 5, wherein the multifilament weft fibers comprise a material that is different from the material of the monofilament weft fibers.

7. The low-noise conveyor belt of claim 1, wherein the woven and non-woven layers are impregnated with the elastomer.

8. The low-noise conveyor belt of claim 7, wherein the non-woven layer comprises polyester, and elastomer comprises polychloroprene.

9. A conveyor belt structure comprising:
a layer of non-woven material; and
a layer of woven material comprising monofilament weft fibers and multifilament warp fibers; and
an elastomer in contact with the first and second layers to fix the layers together;
wherein the first layer of non-woven material is needled to said layer of woven material so that at least some of the staple fibers are interlocked with at least some of the warp and weft fibers.

10. The conveyor belt structure of claim 9, wherein the layer of woven material comprises a plurality of woven layers connected to each other by the elastomer; and wherein monofilament weft fibers of adjacent woven layers are vertically offset from each other by a predetermined distance to provide the belt with a desired lateral stiffness.

11. The conveyor belt structure of claim 9, wherein the layer of non-woven material and the layer of woven material are impregnated with the elastomer.

12. The conveyor belt structure of claim 11, wherein the elastomer comprises polychloroprene.

13. The conveyor belt structure of claim 9, wherein the woven layer comprises a weave selected from the list consisting of plain weave, twill weave, broken twill weave, leno weave, straight warp weave, crow foot weave, oxford weave, S-weave, and A-weave.

14. The conveyor belt structure of claim 9, wherein the layer of non-woven material is impregnated with the elastomer and has a surface pattern embossed on an outer surface thereof.

15. The conveyor belt structure of claim 9, wherein the layer of woven material further comprises a plurality of multifilament weft fibers.

16. The conveyor belt structure of claim 15, wherein the multifilament weft fibers comprise a material that is different from the material of the monofilament weft fibers.

17. A method of making a conveyor belt structure, comprising:
providing a non-woven layer;
providing a woven layer have a plurality of monofilament weft fibers and a plurality of multifilament warp fibers;
needling the first non-woven layer to the first woven layer;
applying an elastomeric material to at least the woven layer; and
curing the elastomeric material to lock the layers together.

18. The method of claim 17, wherein the step of providing a woven layer comprises providing a plurality of woven layers.

19. The method of claim 17, wherein the step of applying an elastomeric material comprises a calendering process.

20. The method of claim 17, further comprising dipping the non-woven layer and the woven layer in resorcinol formaldehyde latex (RFL).

21. The method of claim 17, wherein the first non-woven layer and the first woven layer are provided in roll form, and the steps of disposing the first non-woven layer on the first woven layer and needling the first non-woven layer to the first woven layer are performed by rolling out the layers and continuously feeding them into a needling apparatus.

22. The method of claim 17, further comprising a second non-woven layer, the first and second non-woven layers being disposed on opposite surfaces of the first woven layer.

23. The method of claim 17, wherein the elastomeric compound comprises polychloroprene.

24. The method of claim 21, wherein the step of applying an elastomeric material comprises submerging the woven layer and the non-woven layer in a bath of liquid elastomer.

25. The method of claim 21, wherein the step of applying an elastomeric material comprises an extrusion coating process.
